(19) United States
(12) Patent Application Publication
(10) Pub. No.: US 2017/0255999 A1
(43) Pub. Date: Sep. 7, 2017

(54) PROCESSING SYSTEM TO PREDICT PERFORMANCE VALUE BASED ON ASSIGNED RESOURCE ALLOCATION

(71) Applicants: Jennifer Maia Amaral, Simsbury, CT (US); Cheryl L. Cutright, Farmington, CT (US); Brian James Decker, Davidson, NC (US); Jason A. Dzurka, Charlotte, NC (US); Susan R. Palladino, Bristol, CT (US); Andrea L. Savastra, Newington, CT (US); Anthony Scavotto, Enfield, CT (US); Thomas Andrew Tipton, Milton, GA (US); Kerry S. Uerkwitz, Suwanee, GA (US); Wendy A. Wojdyl, West Hartford, CT (US)

(72) Inventors: Jennifer Maia Amaral, Simsbury, CT (US); Cheryl L. Cutright, Farmington, CT (US); Brian James Decker, Davidson, NC (US); Jason A. Dzurka, Charlotte, NC (US); Susan R. Palladino, Bristol, CT (US); Andrea L. Savastra, Newington, CT (US); Anthony Scavotto, Enfield, CT (US); Thomas Andrew Tipton, Milton, GA (US); Kerry S. Uerkwitz, Suwanee, GA (US); Wendy A. Wojdyl, West Hartford, CT (US)

(21) Appl. No.: 15/060,824

(22) Filed: Mar. 4, 2016

(51) Int. Cl. G06Q 40/08; G06F 3/0482; G06Q 10/06

(52) U.S. Cl. CPC G06Q 40/08; G06Q 10/0631; G06F 3/0482

(57) ABSTRACT

According to some embodiments, an automated resource allocation interface may receive, for a plurality of resource allocation categories, a selected sub-category from a set of potential sub-categories. Based on the selected sub-categories, a resource allocation score may be calculated, and the enterprise system may be assigned to a resource allocation level. A back-end application computer server may access electronic records representing a plurality of potential associations and, for each potential association, a set of attribute variables. Based on the set of attribute variables, a present total number of associations may be generated. Based on the assigned resource allocation level and the set of attribute variables, a future change to the total number of associations may be forecast. Based on the forecasted future change to the total number of associations, a predicted performance value associated with the enterprise system may be calculated and transmitted to generate a user interface display.

### BACKGROUND

In some cases, a performance value associated with an enterprise system may depend at least in part on how resources are allocated in connection with that enterprise system. For example, the performance value might change depending on a total number of associations with the enterprise system (as reflected by electronic records and associated sets of attribute variables) and that total number might, in turn, depend at least in part on how resources are allocated. Moreover, an accurate prediction of the performance value may be desired. Manually predicting the performance value, however, can be a time consuming and error prone process, especially when a substantial number of electronic records and/or attribute variables may influence the behavior of the system. Similarly, a large and diverse number of ways of allocating resources may further complicate such tasks. Note that improving the performance of the system and/or accuracy of performance predictions may result in substantial improvements to the operation of a network (e.g., by reducing an overall number of electronic messages that need to be created and transmitted via the network).

It would be desirable to provide systems and methods to automatically improve the prediction of one or more performance values in a way that provides faster, more accurate results and that allows for flexibility and effectiveness when responding to those results.

### SUMMARY OF THE INVENTION

According to some embodiments, systems, methods, apparatus, computer program code and means are provided to improve the prediction of one or more performance values. In some embodiments, an automated resource allocation interface may receive, for a plurality of resource allocation categories, a selected sub-category from a set of potential sub-categories. Based on the selected sub-categories, a resource allocation score may be calculated, and the enterprise system may be assigned to a resource allocation level. A back-end application computer server may access electronic records representing a plurality of potential associations and, for each potential association, a set of attribute variables. Based on the set of attribute variables, a present total number of associations may be generated. Based on the assigned resource allocation level and the set of attribute variables, a future change to the total number of associations may be forecast. Based on the forecasted future change to the total number of associations, a predicted performance value associated with the enterprise system may be calculated and transmitted to generate a user interface display.

Some embodiments comprise: means for receiving, by an automated resource allocation interface computer for a plurality of resource allocation categories, a selected sub-category from a set of potential sub-categories; means for, based on the selected sub-categories, calculating a resource allocation score for the enterprise system; means for, based on the resource allocation score, assigning the enterprise system to one of a pre-determined number of resource allocation levels; means for automatically accessing, by the back-end application computer server, electronic records from a data store containing electronic records representing a plurality of potential associations and, for each potential association, a set of attribute variables; means for, based on the set of attribute variables, automatically generating a present total number of associations; means for receiving the assigned resource allocation level for the enterprise system; means for, based on the assigned resource allocation level and the set of attribute variables, automatically forecasting a future change to the total number of associations; means for, based at least in part on the forecasted future change to the total number of associations, automatically calculating the predicted performance value associated with the enterprise system; and means for transmitting an indication of the predicted performance value associated with the enterprise system to generate an interactive user interface display.

In some embodiments, a communication device associated with a back-end application computer server exchanges information with remote devices. The information may be exchanged, for example, via public and/or proprietary communication networks.

A technical effect of some embodiments of the invention is an improved and computerized ways to automatically improve the prediction of one or more performance values to provide faster, more accurate results and that allow for flexibility and effectiveness when responding to those results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is a resource allocation process flow in accordance with some embodiments of the present invention.

FIG. 4 illustrates generation of a predicted performance value according to some embodiments.

FIG. 5 illustrates a “gold” level resource allocation display according to some embodiments of the present invention.

FIG. 6 illustrates an exemplary “gold” level attributes and results display that might be associated with various embodiments.

FIGS. 7 and 8 illustrate “silver” level displays according to some embodiments of the present invention.

FIGS. 9 and 10 illustrate “bronze” level displays that might be associated with various embodiments.

FIG. 11 is a block diagram of an apparatus in accordance with some embodiments of the present invention.

FIG. 12 is a portion of a tabular resource allocation database in accordance with some embodiments.

FIG. 13 is a portion of a tabular employee census database according to some embodiments.

FIG. 14 is a portion of a tabular pricing prediction database in accordance with some embodiments.

FIG. 15 illustrates an enrollment strategy pre-sale process according to some embodiments.

FIG. 16 illustrates an enrollment strategy finalist quote stage process according to some embodiments.

FIG. 17 illustrates an enrollment sold case implementation process according to some embodiments.

FIG. 18 illustrates a system having a predictive model in accordance with some embodiments.

FIG. 19 illustrates a tablet computer displaying a resource allocation user interface according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of one or more performance values predictions by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be processed, forecast, and/or predicted via a back-end application server and results may then be analyzed accurately to evaluate the accuracy of various results, thus improving the overall performance of the system associated with message storage requirements and/or bandwidth considerations (e.g., by reducing the number of messages that need to be transmitted via a network). Moreover, embodiments associated with predictive models might further improve performance values, predictions of performance values, resource allocation decisions, etc.

A performance value associated with an enterprise system may depend at least in part on how resources are allocated in connection with that enterprise system. For example, the performance value might change depending on a total number of associations with the enterprise system (as reflected by electronic records and associated sets of attribute variables) and that total number might, in turn, depend at least in part on how resources are allocated. Moreover, an accurate prediction of the performance value may be desired. Manually predicting the performance value, however, can be a time consuming and error prone process, especially when a substantial number of electronic records and/or attribute variables may influence the behavior of the system. Similarly, a large and diverse number of ways of allocating resources may further complicate such tasks. Note that improving the performance of the system and/or accuracy of performance predictions may result in substantial improvements to the operation of a network.

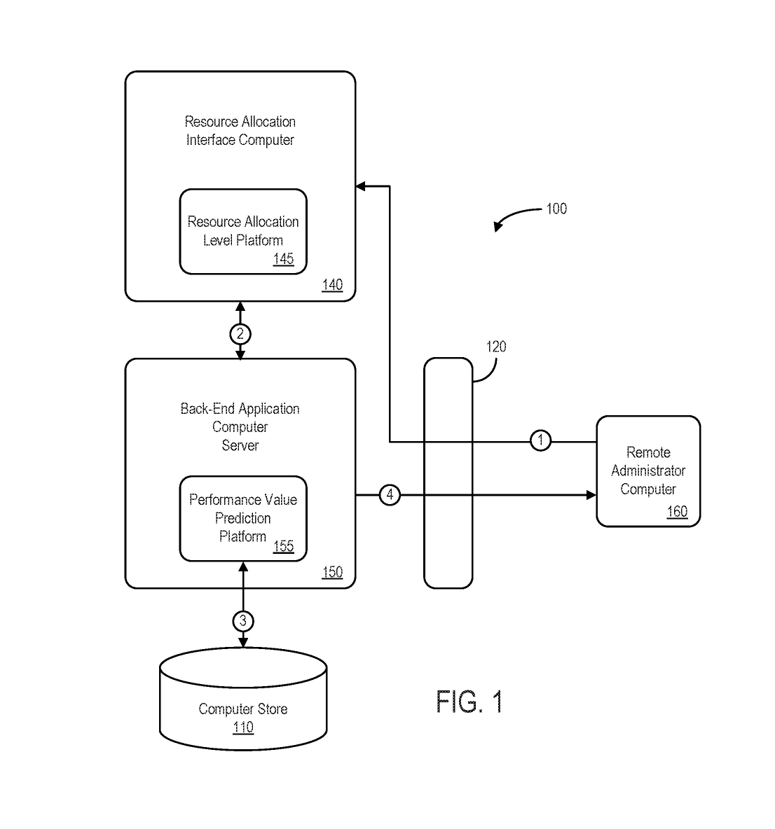

It would be desirable to provide systems and methods to automatically improve the prediction of one or more performance values in a way that provides faster, more accurate results and that allows for flexibility and effectiveness when responding to those results. FIG. 1 is a high-level block diagram of a system 100 according to some embodiments of the present invention. In particular, the system 100 includes a back-end application computer server 150 that may access information in a computer store 110 (e.g., storing a set of electronic records representing risk associations, each record including one or more communication addresses, attribute variables, etc.). The back-end application computer server 150 may also exchange information with a remote administrator computer 160 (e.g., via a firewall 120). According to some embodiments, a performance value prediction platform 155 of the back-end application computer server 150 may facilitate forecasts, predictions, and/or the display of results via one or more remote administrator computers 160. A resource allocation interface computer 140 and/or a resource allocation level platform 145 executing at the computer 140 may exchange information with the back-end application computer server 150 and/or remote administrator computer 160. Further note that the back-end application computer server 150 and/or resource allocation interface computer 140 might be associated with a third party, such as a vendor that performs a service for an enterprise.

The back-end application computer server 150 and/or resource allocation interface computer 140 might be, for example, associated with a Personal Computer (“PC”), laptop computer, smartphone, an enterprise server, a server farm, and/or a database or similar storage devices. According to some embodiments, an “automated” back-end application computer server 150 and/or resource allocation interface computer 140 may facilitate the prediction of a performance value based on electronic records in the computer store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might, for example, store electronic records representing a plurality of potential associations, each electronic record having a set of attribute values. The computer store 110 may also contain information about past and current interactions with parties, including those associated with remote communication devices. The computer store 110 may be locally stored or reside remote from the back-end application computer server 150. As will be described further below, the computer store 110 may be used by the back-end application computer server 150 to predict one or more performance values. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may automatically predict a performance value via the automated back-end application computer server 150. For example, at (1) the remote administrator computer 160 may provide inputs to the resource allocation interface computer 140. At (2), the resource allocation interface computer 140 might transmit information to the back-end application computer server 150 (e.g., indicating a resource allocation level). The performance value prediction platform 155 may then access information in the computer store at (3) and transmit a predicted performance value to the administrator computer at (4).

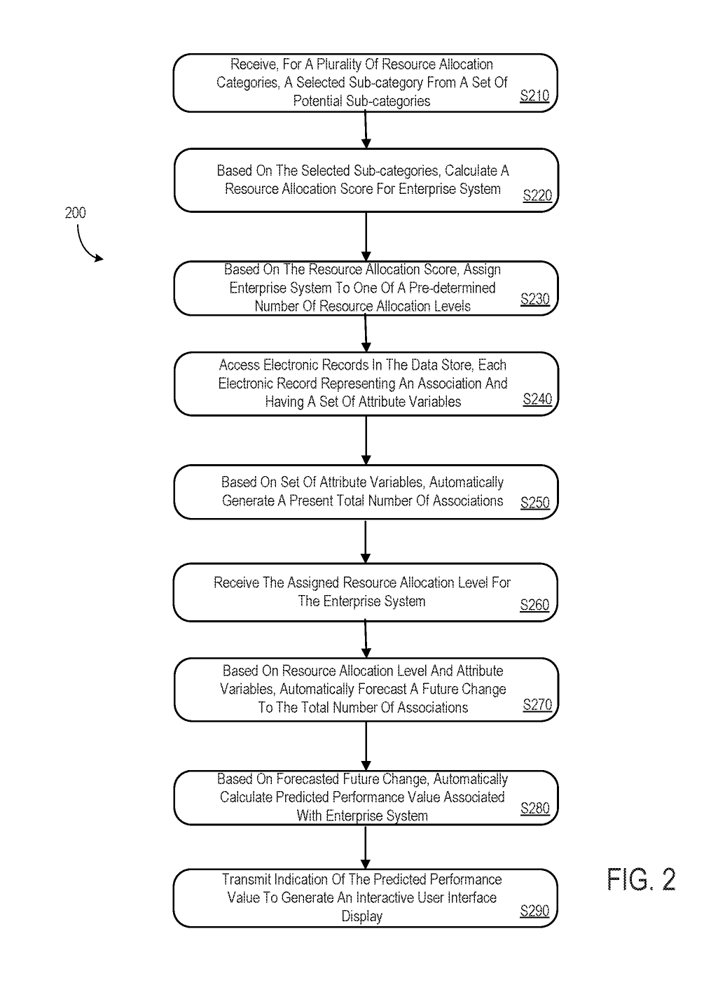

Note that the system 100 of FIG. 1 is provided only as an example, and embodiments may be associated with additional elements or components. According to some embodiments, the elements of the system 100 automatically transmits predicted performance value over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an automated resource allocation interface computer programmed may receive, for a plurality of resource allocation categories, a selected sub-category from a set of potential sub-categories. For example, at least one potential sub-category might be associated with a passive association processes, an active association process, and/or a negative association process. Based on the selected sub-categories, at S220 the system may calculate a resource allocation score for an “enterprise system.” As used herein, the phrase “enterprise system” might refer to, for example, an employer, trade association, etc. At S230, based on the resource allocation score, the enterprise system may be assigned to one of a pre-determined number of resource allocation levels.

According to some embodiments, the automated resource allocation interface comprises a voluntary group insurance benefit enrollment strategy interface, the “resource allocation levels” are associated with a marketing budget allocation (e.g., a “gold,” “silver,” or “bronze” level), and the resource allocation categories include an employee election style, an enrollment method, an employee access and communications process, a marketing strategy, a producer status, and/or a pricing event. Moreover, the potential sub-categories might include a passive election style, an active election style, a negative election style, generic paper enrollment, personized paper enrollment, online and mixed enrollment, benefit fair and group optional communications, email and telephonic communications, one-on-one communications, a generic marketing strategy, a one or two touch marketing strategy, a three or more touch marketing strategy, a very important person producer status indication, a new pricing event, and/or an in-force pricing event.

At S240, an automated back-end application computer server may access electronic records that represent a plurality of potential “associations” and, for each potential association, a set of attribute variables. As used herein, the term “associations” might refer to risk sharing associations such as those associated with potential voluntary benefit insurance policies. The voluntary benefit insurance policies might be associated with, for example, life insurance, accidental death and dismemberment insurance, short term disability insurance, long-term disability insurance, critical illness insurance, voluntary accident insurance, dental insurance, vision insurance, automotive insurance, and/or home insurance. Moreover, the set of attribute variables might include, for example, an enrollment type, gender, an age or date of birth value or band of values, an income value or band of values, demographic information, socio-economic status data, third party data (e.g., third party credit score data), and/or medical data (e.g., associated with employee medical history costs).

Based on the set of attribute variables, at S250 the system may automatically generate a present total number of associations (e.g., how many employees have already enrolled in a group benefit program). At S260, the back-end application computer server may receive the assigned resource allocation level for the enterprise system. Based on the assigned resource allocation level and the set of attribute variables, at S270 the system may automatically forecast a future change to the total number of associations. For example, the system might forecast that a 3% increase in participation is expected (e.g., based on the marketing budget dedicated to educating employs about a particular benefit). Note that the future change to the total number of associations might include, for example, new employees predicted to be hired in the future, employees predicted to retire in the future employee movement between age bands in the future, employee movement between income bands in the future.

At S280, based at least in part on the forecasted future change to the total number of associations, the system may automatically calculate the predicted performance value associated with the enterprise system. According to some embodiments, risk information is calculated for the automatic forecast of the future change to the total number of associations, and the predicted performance value is further based on the risk information.

According to some embodiments, the automatic forecast of the future change to the total number of associations is based at least in part on an association type, at least one time-related attribute variable (e.g., employee ages), and/or elements of the present total number of associations within bands of time periods for the time-related attribute value. According to some embodiments, the automatic forecast of the future change to the total number of associations is further based at least in part on characteristics associated with individual elements within each time period band (e.g., employees who are between 40 years old and 45 years old). According to still other embodiments, the predicted performance value associated with an employer comprises at least one of: a predicted price, a predicted loss ratio, and/or a predicted combined loss ratio. Moreover, according to some embodiments, risk information is calculated for the automatic forecast of the future change to the total number of associations, and the predicted performance value is further based on the risk information. The risk information might comprise or be associated with, for example, an overall number of insurance claims, and (ii) an overall insurance claim value amount. At S290, an indication of the predicted performance value associated with the enterprise system may be transmitted to generate an interactive user interface display.

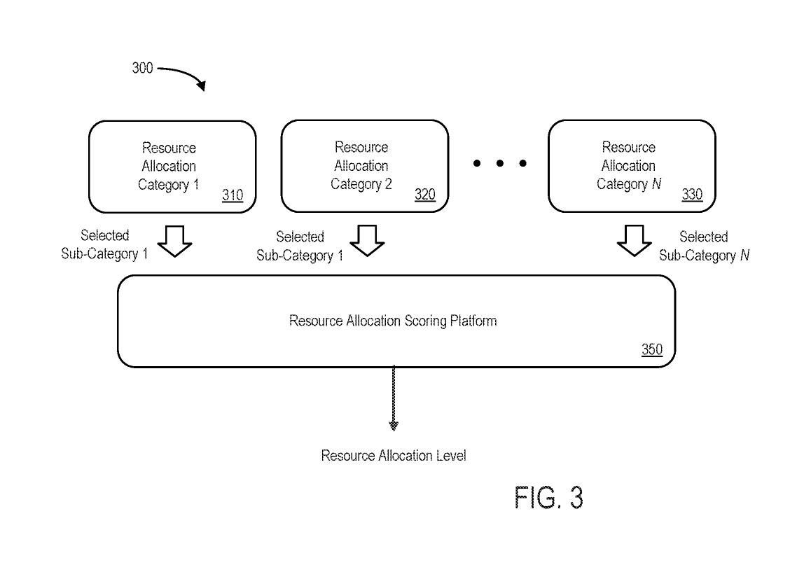

FIG. 3 is a resource allocation process flow 300 in accordance with some embodiments of the present invention. In particular, the process flow 300 includes a resource allocation scoring platform 350 that receives selected sub-categories from a number of resource allocation categories 310, 320, 330 (1 through N). The resource allocation scoring platform 350 might, for example, calculate a resource allocation score as follows:

score=Σᵢ₌₁^{i=N}Wᵢsub_categoryᵢ

where wᵢ represents a scoring weight for each sub-categoryᵢ (e.g., as defined in a resource allocation scoring table). The resource allocation scoring platform 350 might, according to some embodiments, then assign a resource allocation level based on the overall score that was calculated (e.g., a “gold,” “silver,” or “bronze” level).

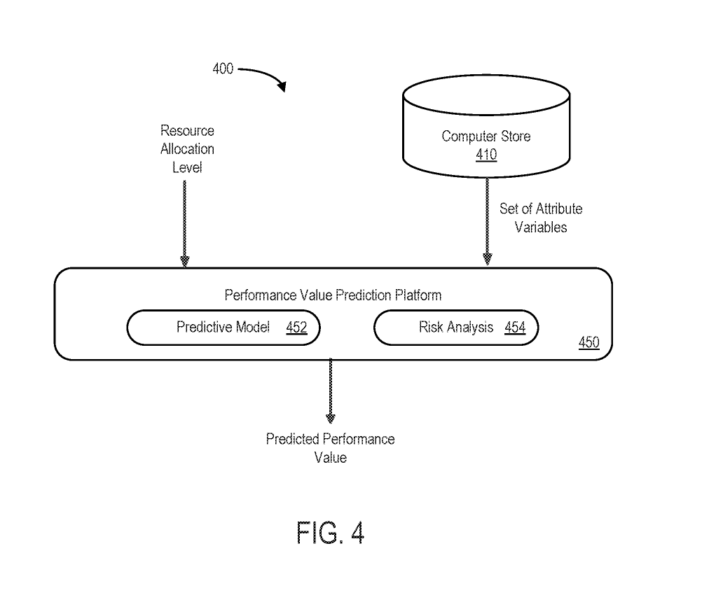

According to some embodiments, the resource allocation level determined in FIG. 4 is used to predict a performance value for an enterprise system (e.g., an employer). For example, FIG. 4 illustrates generation 400 of a predicted performance value according to some embodiments. In this case, a performance value prediction platform 450 receives the resource allocation level and a set of attribute variables from a computer store 410 (e.g., including employee genders, ages, incomes, current insurance enrollments, etc.). A predictive model 452 may then forecast an expected change in current insurance enrollments. This value may then be used to calculate and output a predicted performance value (e.g., a loss ratio or combined loss ratio for a voluntary insurance benefit program). According to some embodiments, a risk analysis 454 might be performed to further refine the forecasts and predictions (e.g., based on a predicted number of insurance claims that are expected to be associated with the forecasted expected change in current insurance enrollments).

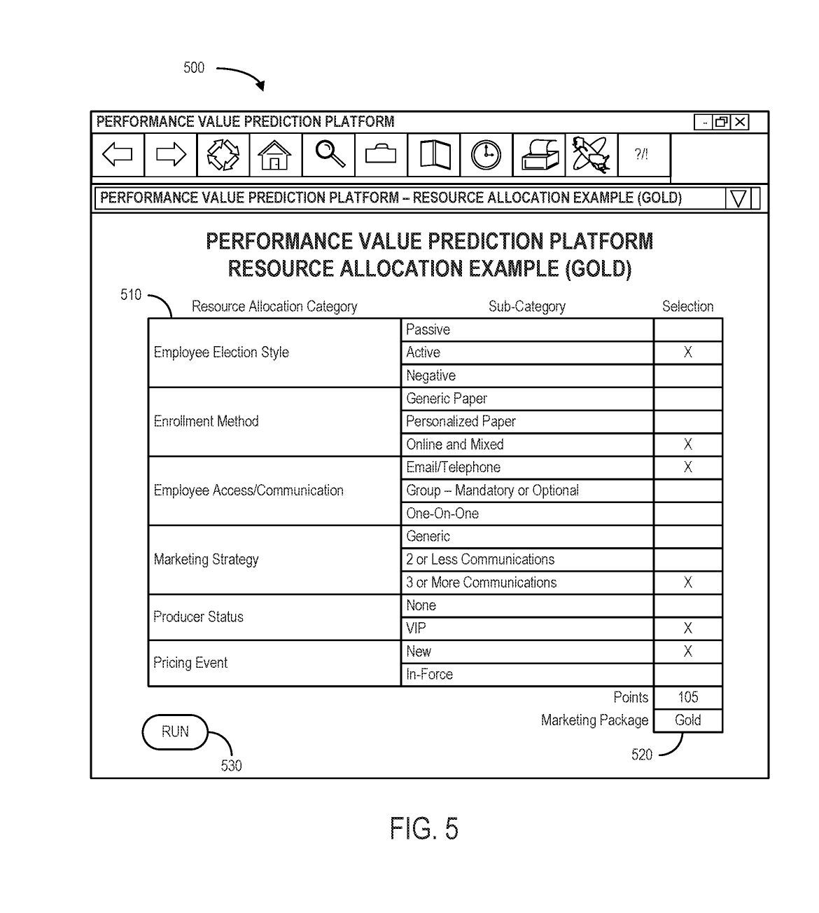

FIG. 5 illustrates a “gold” level resource allocation display 500 according to some embodiments of the present invention. In particular, the resource allocation display 500 includes a category selection area 510 where a user may select one sub-category for each of the categories. For example, in the case of the “employee election style” category the user might select a “passive,” “active,” or “negative” sub-category (e.g., associated with various opt-out, opt-in approaches, etc.). Note that different selections might increase, or decrease, the likelihood that employees will enroll in the voluntary group benefits insurance program. Other examples of resource allocation categories include “enrollment method,” “employee access/communication,” “marketing strategy,” “producer status,” and “pricing event.” The display 500 further includes an overall number of points and marketing package level 520 that is automatically calculated based on the user's selections. According to some embodiments, selection of a “Run” icon 530 might cause the system to perform such a calculation. Further note that, according to some embodiments, some or all of the information in the display might be auto-populated (e.g., based on last year's selections) and/or be based on an optimization model.

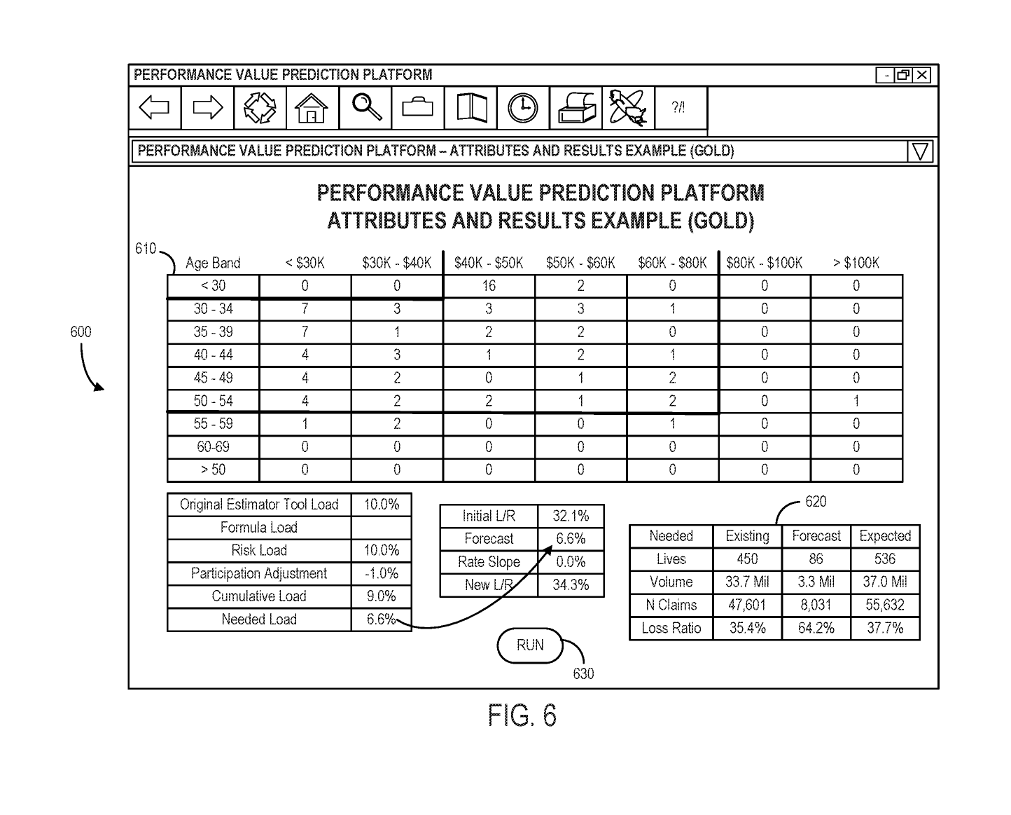

FIG. 6 illustrates an exemplary “gold” level attributes and results display 600 that might be associated with various embodiments. Note that FIGS. 5 through 10 may illustrate a pricing initiative that forecasts employee enrollment for supplemental life insurance on a case-by-case basis. General factors that might be taken into account when forecasting enrollments include, but are not limited to: medical evidence (enrollment type), a selected marketing package that describes the level of marketing (e.g., with more marketing leading to more enrollment), and current employee participation.

In general, when forecasting the system might not only focus on the number of new lives, but instead also look at the age and socio-economic status of the forecasted lives (employees). Individuals who are young and have a relatively low salaries may be less likely to purchase life insurance because they have less disposable income to purchase insurance (or may not be well informed about insurance options and benefits). Older individuals and individuals with relatively higher salaries may also be less likely to purchase life insurance because they have often already researched the subject (and have already purchased supplemental life insurance through the employer or have made a decision to purchase insurance elsewhere).

The illustrations described with respect to FIGS. 5 through 10 are all for the same case. The only difference between each of the three illustrations is the resource allocation marketing package: Gold, Silver, or Bronze. Some of the common values associated with these examples include:
1,434 eligible lives and 450 lives currently enrolled in supplemental life (31%)
manual rate=proposed rate (the load will not be affected by the rating for this case and the load will be comprised solely of the forecasted enrollment)
historical medical evidence: traditional
future medical evidence: open (moving from traditional enrollment to an open enrollment is often where the largest increases in participation occurs)
3 year rate guarantee

Note that it is possible to see slightly different loads even when the same needed percentage is input (that is, the exact same load might not result every time 2% is entered for the needed forecast). This might occur, for example, when the tool re-solves for a penetration level when the overall needed forecast pick is adjusted. This might cause the iterations of the forecasted distribution to differ slightly because the penetration levels that are being solved for can have many decimal places (allowing more than one solution to be correct).

The example of FIGS. 5 and 6 are associated with a gold level resource allocation. Note that gold marketing packages and open enrollment may provide a relatively large opportunity for additional participation. Employees may be highly informed of their opportunity to purchase supplemental life coverage, and new entrants will not have to submit Evidence Of Insurability (“EOI”) documentation and current enrolled employees can increase coverage without EOI up to a specified Guaranteed Issue (“GI”) amount. Note that the displays 500, 600 may be associated with a low penetration level of 6%, a medium penetration level of 11%, and a high penetration level of 16%. With a margin of 5% and a formula forecast of 5%, a 6% level of participation may be needed. As illustrated in FIG. 6, attribute variables 610 include age bands and income bands with different intersections of those variables producing different likelihoods of participation (as illustrated by the darker lines in the table). Moreover, using the needed load of 6.6% as the forecast results in the Loss Ratio (“L/R”) changing from 32.1% (“Initial”) to 34.3% (“New”). Moreover, results 620 in the display 600 include for existing, forecast, and expected scenarios: lives, volume, N claims, and loss ratio. According to some embodiments, user selection of a “Run” icon might cause the display 600 to be automatically recalculated. The large increase in participation may increase the loss ratio, but the load will not be as high as the standard 10.0% adjustment currently in a life estimate tool.

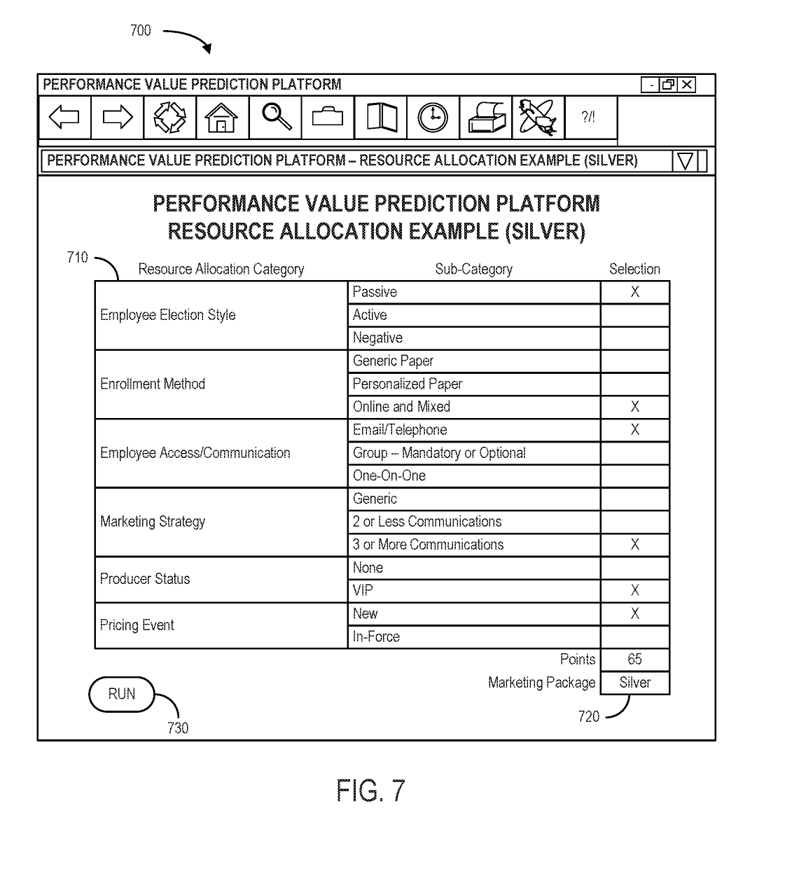

FIG. 7 illustrates a “silver” level resource allocation display 700 according to some embodiments of the present invention. As before, the resource allocation display 700 includes a category selection area 710 where a user may select one sub-category for each of the categories and different selections might increase, or decrease, the likelihood that employees will enroll in the voluntary group benefits insurance program. The display 700 further includes an overall number of points and marketing package level 720 that is automatically calculated based on the user's selections. According to some embodiments, selection of a “Run” icon 730 might cause the system to perform such a calculation.

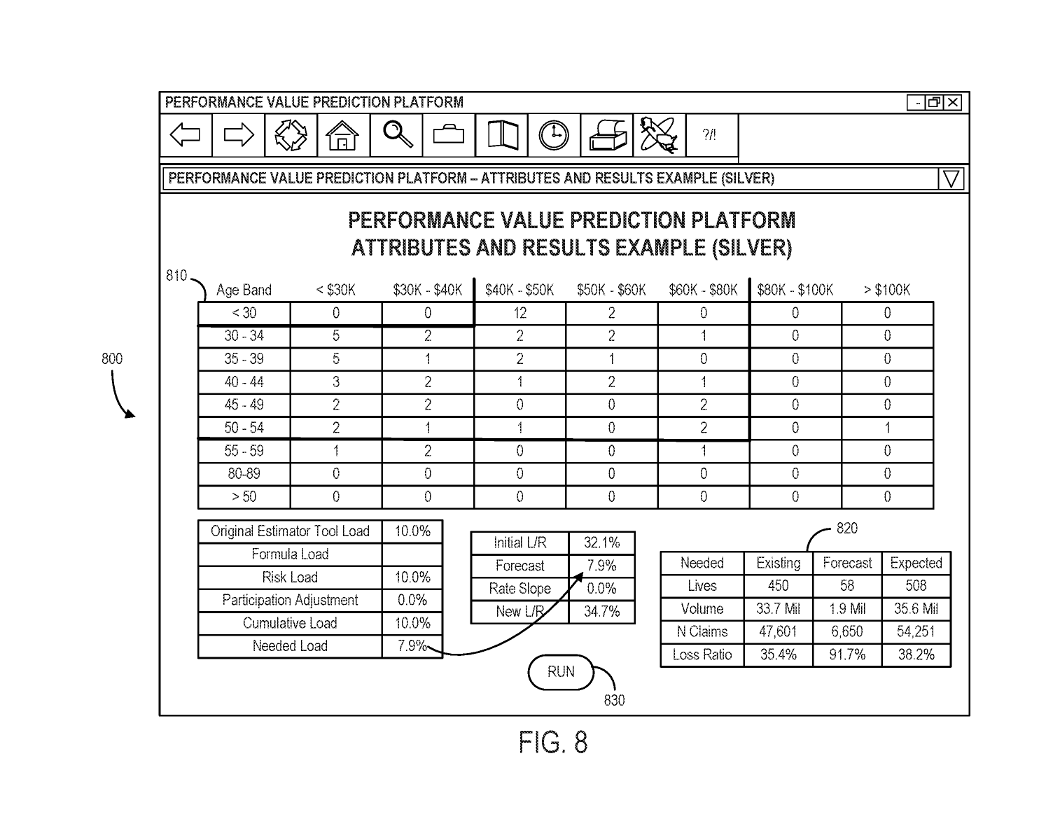

FIG. 8 illustrates an exemplary “silver” level attributes and results display 800 that might be associated with various embodiments. With silver marketing packages and open enrollment, the system may see some opportunity for additional participation (but not as much as with gold marketing). Note that the displays 700, 800 may be associated with a low penetration level of 2%, a medium penetration level of 7%, and a high penetration level of 12%. With a margin of 5% and a formula forecast of 4%, a 4% level of participation may be needed. As illustrated in FIG. 8, attribute variables 810 include age bands and income bands with different intersections of those variables producing different likelihoods of participation (as illustrated by the darker lines in the table). Moreover, using the needed load of 7.9% as the forecast results in the Loss Ratio (“L/R”) changing from 32.1% (“Initial”) to 34.7% (“New”). Moreover, results 820 in the display 800 include for existing, forecast, and expected scenarios: lives, volume, N claims, and loss ratio. According to some embodiments, user selection of a “Run” icon might cause the display 800 to be automatically recalculated. The forecasted participation may increase the loss ratio higher than the gold package did (because of anti-selection risk due to the combination of the current participation and the marketing package level).

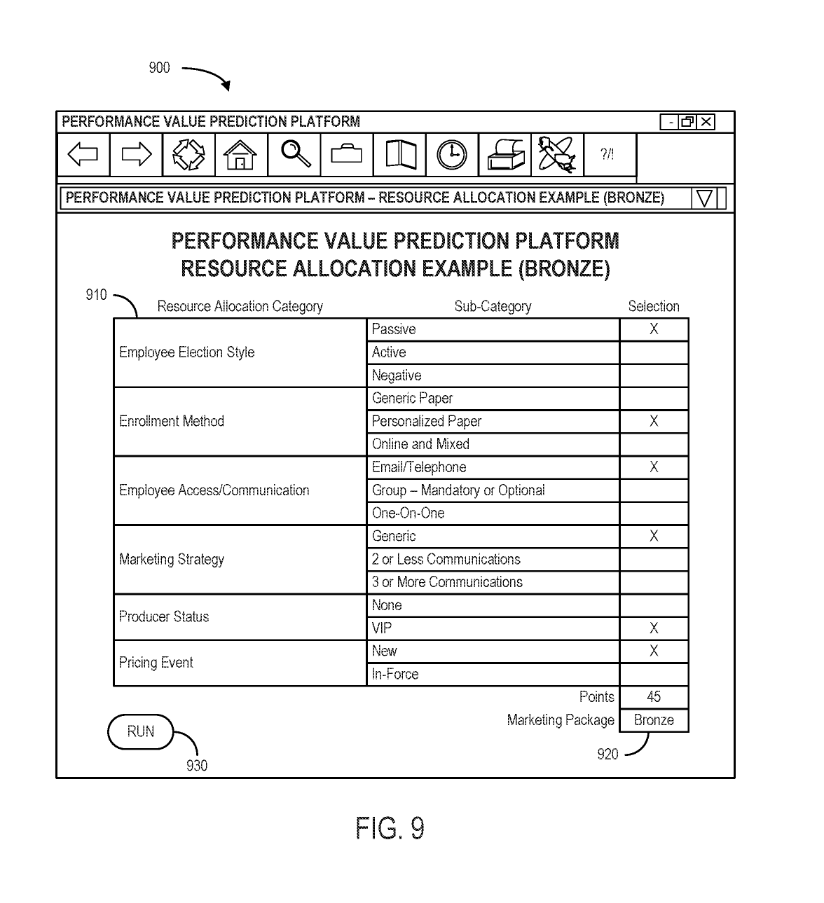

FIG. 9 illustrates a “bronze” level resource allocation display 900 according to some embodiments of the present invention. As before, the resource allocation display 900 includes a category selection area 910 where a user may select one sub-category for each of the categories and different selections might increase, or decrease, the likelihood that employees will enroll in the voluntary group benefits insurance program. The display 900 further includes an overall number of points and marketing package level 920 that is automatically calculated based on the user's selections. According to some embodiments, selection of a “Run” icon 930 might cause the system to perform such a calculation.

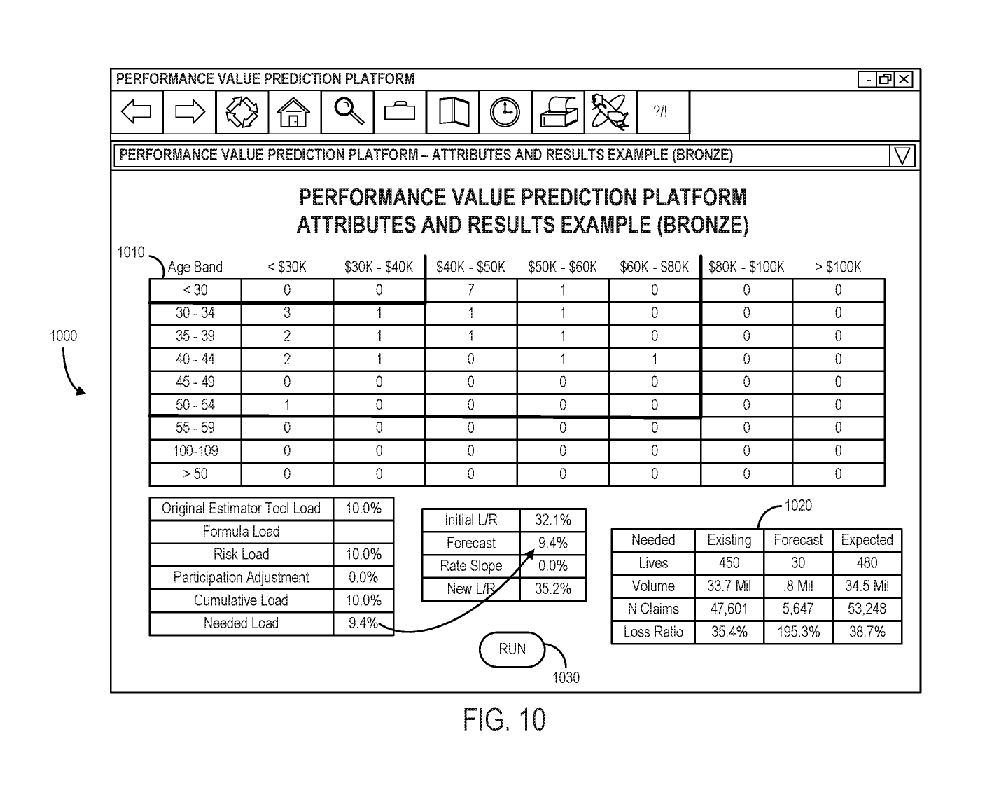

FIG. 10 illustrates an exemplary “bronze” level attributes and results display 1000 that might be associated with various embodiments. With a bronze marketing packages and open enrollment, the system may see little opportunity for additional participation. With relatively little marketing, only those showing initiative will likely receive more information about enrollment. Note that the displays 900, 1000 may be associated with a low penetration level of 0%, a medium penetration level of 2%, and a high penetration level of 7%. With a margin of 5% and a formula forecast of 2%, a 2% level of participation may be needed. As illustrated in FIG. 10, attribute variables 1010 include age bands and income bands with different intersections of those variables producing different likelihoods of participation (as illustrated by the darker lines in the table). Moreover, using the needed load of 9.4% as the forecast results in the Loss Ratio (“L/R”) changing from 32.1% (“Initial”) to 35.2% (“New”). Moreover, results 1020 in the display 1000 include for existing, forecast, and expected scenarios: lives, volume, N claims, and loss ratio. According to some embodiments, user selection of a “Run” icon might cause the display 1000 to be automatically recalculated. The forecasted participation may increase the loss ratio higher than the gold and silver packages did (because of anti-selection risk due to the combination of the current participation and the marketing package level). Note that forecasted participation may increase the loss ratio higher than the silver package. With the current participation and the low marketing level, the system may expect the anti-selection risk to be higher in this scenario. Given the current participation percentage for this group, those who seek out supplemental coverage with little marketing might include only those who really need it.

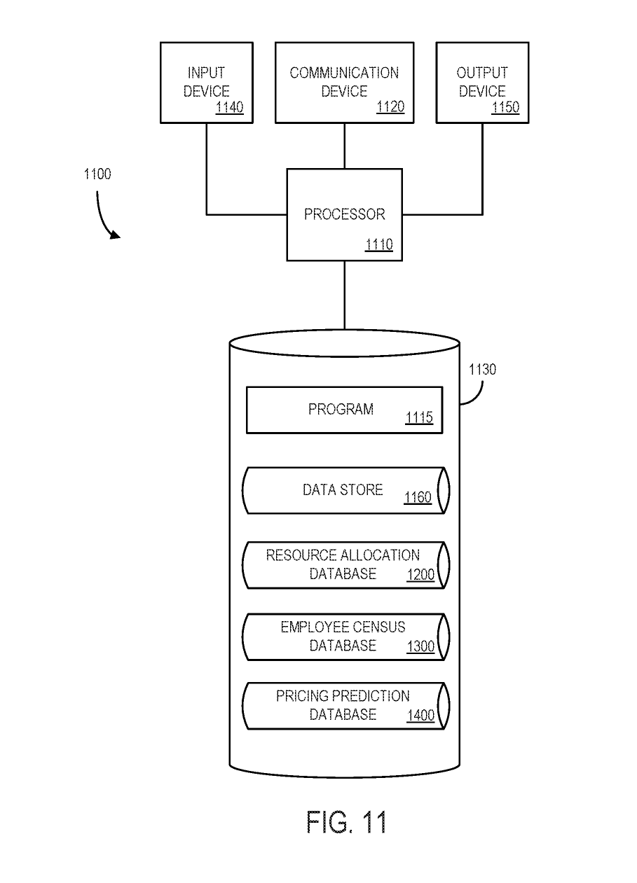

The embodiments described herein may be implemented using any number of different hardware configurations. For example, FIG. 11 illustrates a back-end application computer server 1100 that may be, for example, associated with the system 100 of FIG. 1. The back-end application computer server 1100 comprises a processor 1110, such as one or more commercially available Central Processing Units (“CPUs”) in the form of one-chip microprocessors, coupled to a communication device 1120 configured to communicate via a communication network (not shown in FIG. 11). The communication device 1120 may be used to communicate, for example, with one or more remote administrator computers and or communication devices (e.g., PCs and smartphones). Note that communications exchanged via the communication device 1120 may utilize security features, such as those between a public internet user and an internal network of the insurance enterprise. The security features might be associated with, for example, web servers, firewalls, and/or PCI infrastructure. The back-end application computer server 1100 further includes an input device 1140 (e.g., a mouse and/or keyboard to enter information about employee census data, historic information, predictive models, etc.) and an output device 1150 (e.g., to output reports regarding system administration and/or actual participation levels).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1115 and/or a risk evaluation tool or application for controlling the processor 1110. The processor 1110 performs instructions of the program 1115, and thereby operates in accordance with any of the embodiments described herein. For example, the processor 1110 may receive, for a plurality of resource allocation categories, a selected sub-category from a set of potential sub-categories. Based on the selected sub-categories, a resource allocation score may be calculated by the processor 1110, and the enterprise system may be assigned to a resource allocation level. The processor 1110 may access electronic records representing a plurality of potential associations and, for each potential association, a set of attribute variables. Based on the set of attribute variables, a present total number of associations may be generated by the processor 1110. Based on the assigned resource allocation level and the set of attribute variables, the processor 1110 may forecast a future change to the total number of associations. Based on the forecasted future change to the total number of associations, a predicted performance value associated with the enterprise system may be calculated and transmitted by the processor 1110 to generate a user interface display.

The program 1115 may be stored in a compressed, uncompiled and/or encrypted format. The program 1115 may furthermore include other program elements, such as an operating system, a database management system, and/or device drivers used by the processor 1110 to interface with peripheral devices.

As used herein, information may be “received” by or “transmitted” to, for example: (i) the back-end application computer server 1100 from another device; or (ii) a software application or module within the back-end application computer server 1100 from another software application, module, or any other source.

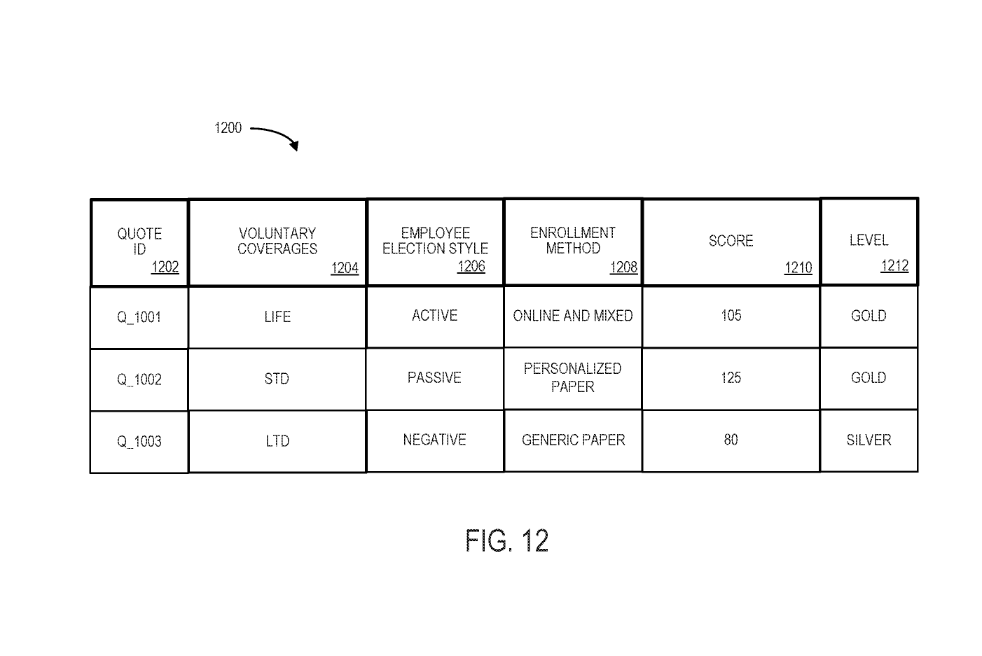

In some embodiments (such as shown in FIG. 11), the storage device 1130 further stores a computer data store 1160 (e.g., associated with a set of destination communication addresses, attribute variables, etc.), a resource allocation database 1200, an employee census database 1300, and a pricing prediction database 1400. Examples of databases that might be used in connection with the back-end application computer server 1100 will now be described in detail with respect to FIGS. 12 through 14. Note that the databases described herein are only examples, and additional and/or different information may be stored therein. Moreover, various databases might be split or combined in accordance with any of the embodiments described herein. For example, the computer data store 1160 and/or resource allocation database 1200 might be combined and/or linked to each other within the program 1115.

Referring to FIG. 12, a table is shown that represents the resource allocation database 1200 that may be stored at the back-end application computer server 1100 according to some embodiments. The table may include, for example, entries associated with an insurer's marketing budget. The table may also define fields 1202, 1204, 1206, 1208, 1210, 1212 for each of the entries. The fields 1202, 1204, 1206, 1208, 1210, 1212 may, according to some embodiments, specify: a quote identifier 1202, voluntary coverages 1204, employee election style 1206, an enrollment method 1208, score 1210, and a level 1212. The resource allocation database 1200 may be created and updated, for example, based on information electrically received from a user or administrator and/or as calculations are automatically performed.

The quote identifier 1202 may be, for example, a unique alphanumeric code identifying an insurer, employer, and/or insurance quote. The voluntary coverages 1204 might illustrate a type of insurance (e.g., life, Short Term Disability (“STD”), Long Term Disability (“LTD”), etc.). The employee election style 1206 (e.g., active, passive, or negative) and enrollment method 1208 (online, personalized paper, etc.) may be values that are entered by a user. The score 1210 may then be calculated by the system (e.g., based on the employee election style 1206 and enrollment method 1208). Once the score 1210 is calculated, the level 1212 may be automatically determined (e.g., with quotes receiving a score 1210 from “70” to “90” receiving a “silver” level 1212 rating) and used to forecast future changes in participation.

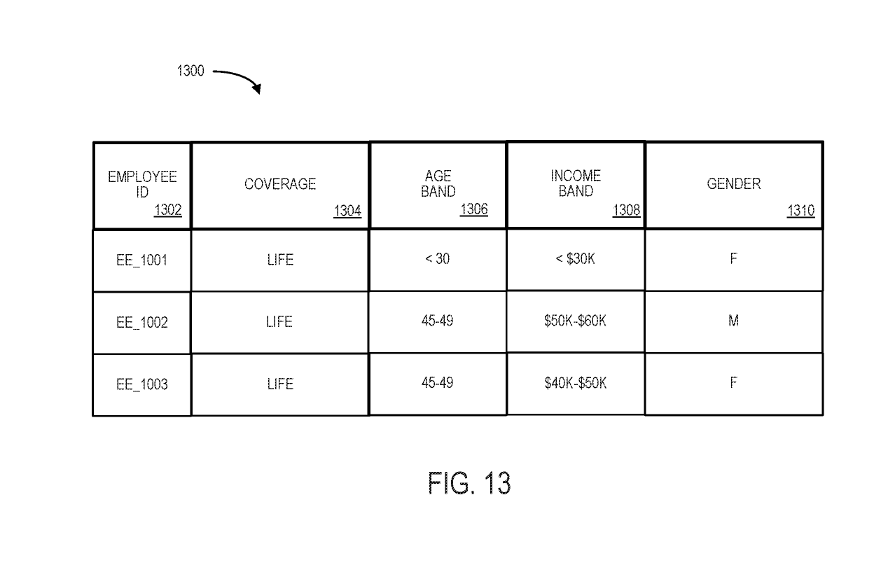

Referring to FIG. 13, a table is shown that represents the employee census database 1300 that may be stored at the back-end application computer server 1100 according to some embodiments. The table may include, for example, entries associated with employees who are eligible to participate in voluntary insurance coverages. The table may also define fields 1302, 1304, 1306, 1308, 1310 for each of the entries. The fields 1302, 1304, 1306, 1308, 1310, 1312 may, according to some embodiments, specify: an employee identifier 1302, coverage 1304, age band 1306, income band 1308, and gender 1310. The employee census database 1300 may be created and updated, for example, based on electronic records received from an employer or maintained by an insurer.

The employee identifier 1302 may be, for example, a unique alphanumeric code identifying an employee who works for an employer. The coverage 1304 may indicate a type of voluntary insurance. The age band 1306, income band 1308, and gender 1310 (e.g., male or female) may define demographic characteristics associated with the employee that can be used to forecast future changes in participation.

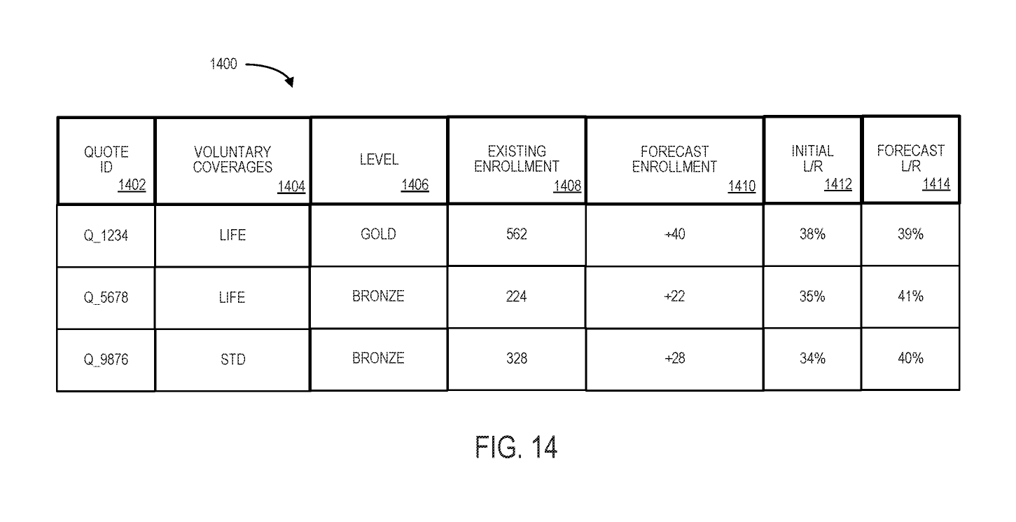

Referring to FIG. 14, a table is shown that represents the pricing prediction database 1400 that may be stored at the back-end application computer server 1100 according to some embodiments. The table may include, for example, entries associated with an insurance quote. The table may also define fields 1402, 1404, 1406, 1408, 1410, 1412, 1414 for each of the entries. The fields 1402, 1404, 1406, 1408, 1410, 1412, 1414 may, according to some embodiments, specify: a quote identifier 1402, voluntary coverages 1404, level 1406, existing enrollment 1408, a forecast enrollment 1410, an initial loss ratio 1412, and a forecast loss ratio 1414. The pricing prediction database 1400 may be created and updated, for example, based on information electrically received and/or as calculations are automatically performed.

The quote identifier 1402 may be, for example, a unique alphanumeric code identifying an insurer, employer, and or insurance quote and may be based on, or associated with, the quote identifier 1202 in the resource allocation database 1200. The voluntary coverages 1404 may describe the types of insurance being offered, and the level 1406 might reflect the resources allocated in the resource allocation database 1200. The existing enrollment 1408 might reflect a number of employees who are currently enrolled and purchasing the voluntary coverages 1404. The forecast enrollment 1410 may represent a forecast change to the existing enrollment 1408. The initial loss ratio 1412 and forecast ratio 1414 may then be calculated in accordance with any of the embodiments described herein.

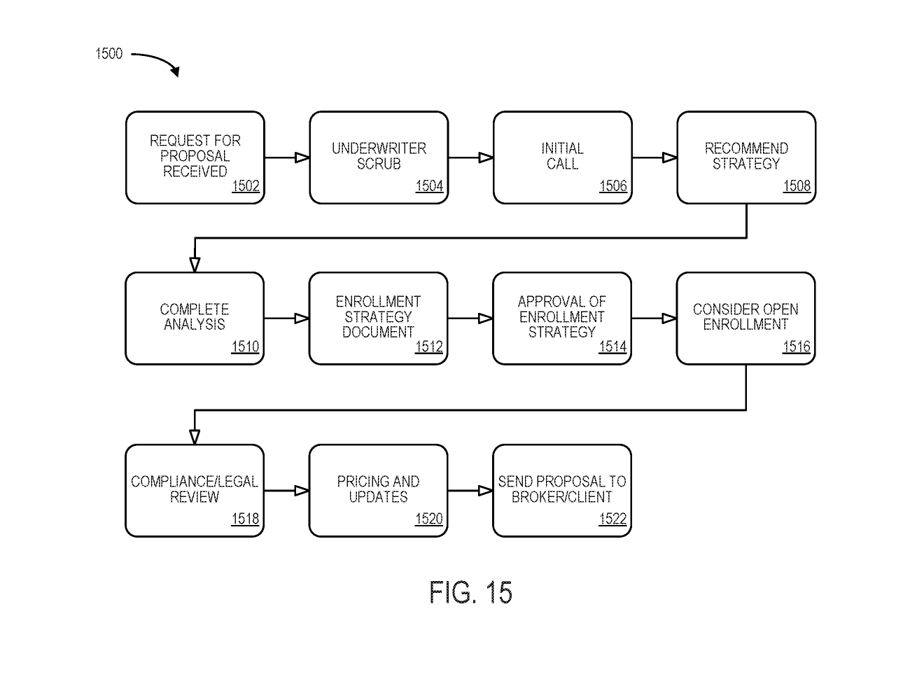

FIG. 15 illustrates an enrollment strategy pre-sale process 1500 according to some embodiments. At 1502, a voluntary request for proposal may be received by an account executive. According to some embodiments, the request for proposal includes historical medical EOI (enrollment type) and frequency for an underwriter to price. An initial questioning document may be completed by the account executive who questions the broker or client to determine appropriate needs and consults with a voluntary sales manager to identify voluntary opportunities, pain points, and positioning. At 1504, the underwriter may perform an initial scrub of the received information to review the case for missing data and ask for following information. At 1506, a presale analyst may conduct a call to explore large or complex regional accounts or national accounts. At 1508, the account executive may receive inputs from the voluntary sales manager, the underwriter, an actuary, and a marketing department and request a voluntary enrollment analysis.

At 1510, a voluntary sales manager might submit the voluntary enrollment analysis form to an analytic consulting team for national accounts. For regional accounts, the voluntary sales manager might execute a voluntary enrollment analysis automated tool. At 1512, the account executive may complete an initial enrollment strategy document (e.g., implemented via the MICROSOFT® EXCEL® spreadsheet application). According to some embodiments, some or all of this information may be further processed via a Customer Relationship Management (“CRM”) cloud-based platform, such as SALESFORCE.COM®. At 1514, the voluntary sales manager might seek approval of an enrollment strategy and provide insights and observations related to participation. At 1516, the underwriter may assess the impacts of enrollment strategy as documented in the enrollment strategy document (and consult with a compliance/legal department as needed) and consider willingness to offer open or modified open enrollment.

At 1518, the compliance/legal department may review for issues and determine if there are issues with filing, rebating or other regulations/laws. At 1520, pricing and updates may be determined and the underwriter may ensure that the enrollment strategy document includes comments on participation and pricing, and a gold, silver, or bronze marketing package might be selected for the quote. At 1522, the proposal may be sent to the broker or client by the account executive, and it may be confirmed that the broker or client agrees to the terms of the enrollment strategy document.

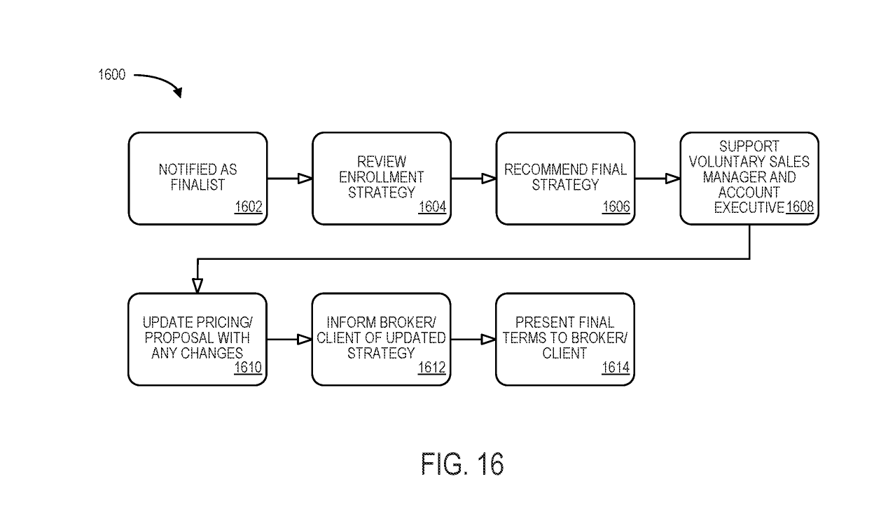

FIG. 16 illustrates an enrollment strategy finalist quote stage process 1600 according to some embodiments. At 1602, a notification may be issued indicating that a finalist quote stage has been reached. At 1604, the enrollment strategy may be reviewed by the account executive. He or she may, for example, determine if any changes are needed, obtain inputs from the voluntary sales manager, underwriter, actuary, and/or marketing department. At 1606, the voluntary sales manager may recommend a final strategy. At 1608, the marketing department may support the voluntary sales manager and account executive by providing ideas to support enrollment campaigns and/or details of potential expenses. At 1610, the underwriter may update pricing/proposal with any changes and provide the final proposal information a team that manages finalist materials. At 1612, the account executive may inform the broker and/or client about the updated enrollment strategy. At 1614, the account executive may present the final terms to the broker and/or client.

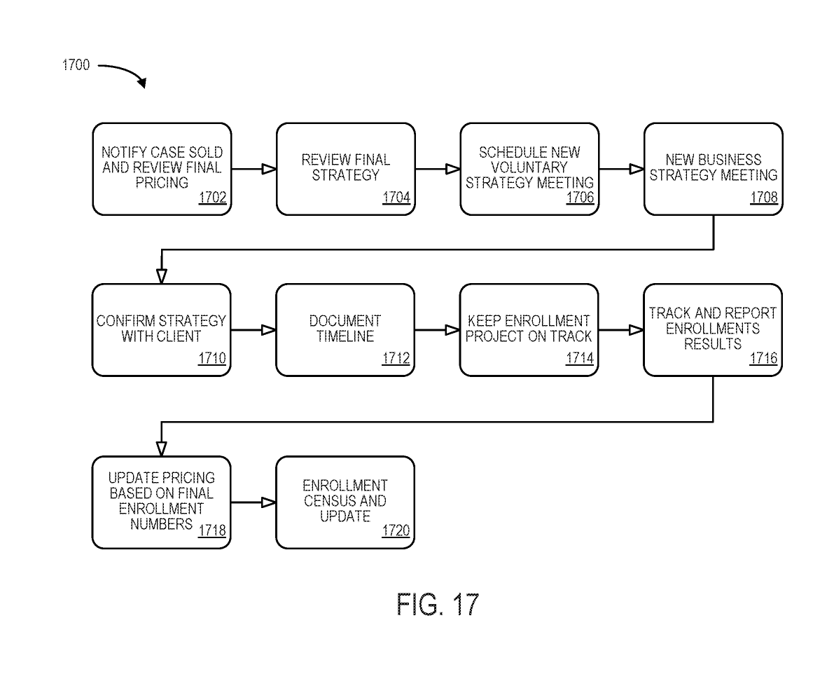

FIG. 17 illustrates an enrollment sold case implementation process 1700 according to some embodiments. At 1702, the account executive may notify that the case was sold and review final pricing. The final enrollment strategy may also be reviewed at 1704 by providing final written sign-off to an implementation manager and/or account manager. At 1706, the implementation manager may schedule a new business strategy meeting. At 1708, the voluntary sales manager may lead the new business strategy meeting. At 1710, the implementation manager may confirm enrollment strategy with client and documents implementation/marketing decisions. At 1712, the implementation manager may document the determined timeline and arrange to keep the enrollment project on track at 1714. At 1716, enrollment strategy may be tracked and enrollment results may be reported. At 1718, pricing may be updated by the underwriter based on final enrollment numbers. At 1720, an enrollment census may be generated and the account manager may update the CRM cloud based application.

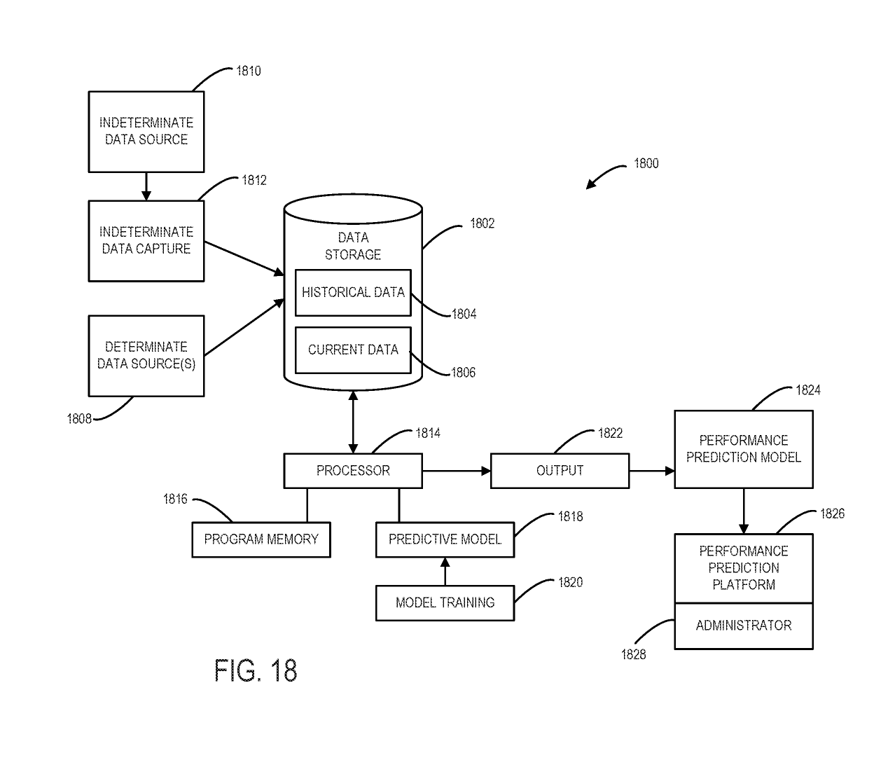

According to some embodiments, one or more predictive models may be used to predict or forecast future events. Features of some embodiments associated with a predictive model will now be described by first referring to FIG. 18. FIG. 18 is a partially functional block diagram that illustrates aspects of a computer system 1800 provided in accordance with some embodiments of the invention. For present purposes it will be assumed that the computer system 1800 is operated by an insurance company (not separately shown) for the purpose of supporting insurance policy audits (e.g., to forecast future events associated with voluntary insurance coverages).

The computer system 1800 includes a data storage module 1802. In terms of its hardware the data storage module 1802 may be conventional, and may be composed, for example, by one or more magnetic hard disk drives. A function performed by the data storage module 1802 in the computer system 1800 is to receive, store and provide access to both historical transaction data (reference numeral 1804) and current transaction data (reference numeral 1806). As described in more detail below, the historical transaction data 1804 is employed to train a predictive model to provide an output that indicates an identified performance metric and/or an algorithm to score performance factors, and the current transaction data 1806 is thereafter analyzed by the predictive model. Moreover, as time goes by, and results become known from processing current transactions (e.g., audit results), at least some of the current transactions may be used to perform further training of the predictive model. Consequently, the predictive model may thereby appropriately adapt itself to changing conditions.

Either the historical transaction data 1804 or the current transaction data 1806 might include, according to some embodiments, determinate and indeterminate data. As used herein and in the appended claims, “determinate data” refers to verifiable facts such as the an age of a business; an automobile type; a policy date or other date; a driver age; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1808 that are included in the computer system 1800 and are coupled to the data storage module 1802. The determinate data may include “hard” data like a claimant's name, date of birth, social security number, policy number, address, an underwriter decision, etc. One possible source of the determinate data may be the insurance company's policy database (not separately indicated).

The indeterminate data may originate from one or more indeterminate data sources 1810, and may be extracted from raw files or the like by one or more indeterminate data capture modules 1812. Both the indeterminate data source(s) 1810 and the indeterminate data capture module(s) 1812 may be included in the computer system 1800 and coupled directly or indirectly to the data storage module 1802. Examples of the indeterminate data source(s) 1810 may include data storage facilities for document images, for text files, and digitized recorded voice files. Examples of the indeterminate data capture module(s) 1812 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1800 also may include a computer processor 1814. The computer processor 1814 may include one or more conventional microprocessors and may operate to execute programmed instructions to provide functionality as described herein. Among other functions, the computer processor 1814 may store and retrieve historical insurance transaction data 1804 and current transaction data 1806 in and from the data storage module 1802. Thus the computer processor 1814 may be coupled to the data storage module 1802.

The computer system 1800 may further include a program memory 1816 that is coupled to the computer processor 1814. The program memory 1816 may include one or more fixed storage devices, such as one or more hard disk drives, and one or more volatile storage devices, such as RAM devices. The program memory 1816 may be at least partially integrated with the data storage module 1802. The program memory 1816 may store one or more application programs, an operating system, device drivers, etc., all of which may contain program instruction steps for execution by the computer processor 1814.

The computer system 1800 further includes a predictive model component 1818. In certain practical embodiments of the computer system 1800, the predictive model component 1818 may effectively be implemented via the computer processor 1814, one or more application programs stored in the program memory 1816, and computer stored as a result of training operations based on the historical transaction data 1804 (and possibly also data received from a third party). In some embodiments, data arising from model training may be stored in the data storage module 1802, or in a separate computer store (not separately shown). A function of the predictive model component 1818 may be to determine appropriate audit techniques for a set of insurance policies. The predictive model component may be directly or indirectly coupled to the data storage module 1802.

The predictive model component 1818 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1800 includes a model training component 1820. The model training component 1820 may be coupled to the computer processor 1814 (directly or indirectly) and may have the function of training the predictive model component 1818 based on the historical transaction data 1804 and/or information about potential insureds. (As will be understood from previous discussion, the model training component 1820 may further train the predictive model component 1818 as further relevant data becomes available.) The model training component 1820 may be embodied at least in part by the computer processor 1814 and one or more application programs stored in the program memory 1816. Thus, the training of the predictive model component 1818 by the model training component 1820 may occur in accordance with program instructions stored in the program memory 1816 and executed by the computer processor 1814.

In addition, the computer system 1800 may include an output device 1822. The output device 1822 may be coupled to the computer processor 1814. A function of the output device 1822 may be to provide an output that is indicative of (as determined by the trained predictive model component 1818) particular performance metrics, insurance claim losses, etc. The output may be generated by the computer processor 1814 in accordance with program instructions stored in the program memory 1816 and executed by the computer processor 1814. More specifically, the output may be generated by the computer processor 1814 in response to applying the data for the current simulation to the trained predictive model component 1818. The output may, for example, be a numerical estimate and/or likelihood within a predetermined range of numbers. In some embodiments, the output device may be implemented by a suitable program or program module executed by the computer processor 1814 in response to operation of the predictive model component 1818.

Still further, the computer system 1800 may include performance prediction module 1824. The performance prediction module 1824 may be implemented in some embodiments by a software module executed by the computer processor 1814. The performance prediction module 1824 may have the function of rendering a portion of the display on the output device 1822. Thus, the performance prediction module 1824 may be coupled, at least functionally, to the output device 1822. In some embodiments, for example, the performance prediction module 1824 may report results and/or predictions by routing, to an administrator 1828 via a performance prediction platform 1826, a results log and/or automatically generated loss ratios generated by the predictive model component 1818. In some embodiments, this information may be provided to an administrator 1828 who may also be tasked with determining whether or not the results may be improved (e.g., by further adjusting models).

In some embodiments described herein, a predictive model may use information from an enrollment strategy document (e.g., allocating a marketing resources budget within various categories) to predict future changes in employee enrollment (and those future changes may be used to adjust a loss ratio, price an insurance policy, etc.). Note, however, that a predictive model may receive other inputs and/or generate other embodiments in accordance with embodiments described herein. For example, a predictive model might receive a desired loss ratio or a desired change in future employee enrollment and use that information to populate the enrollment strategy document (e.g., automatically suggesting marketing resources budget allocations among the various categories). According to some embodiments, the predictive model might be run using several different alternate sets of input values and generate predication for each of those scenarios). As another example, an operator or administrator might select one or more values that should be optimized (e.g., a combined loss ratio) and the system may generate results to facilitate the optimization of that value.

Thus, embodiments may provide an automated and efficient way to address the need for a consistent and objective determination of how to deploy scarce marketing dollars for employee benefit enrollment campaigns. Embodiments may also address the need for a consistent and objective determination of how the potential enrollment will impact the risk profile of insurance coverage and translate that into a case-level price. The resource allocation approaches described herein may utilize an algorithm that scales a marketing budget to offer the most robust tactics to cases with the best potential to bring in voluntary premium. The algorithm may take the case-specific voluntary enrollment marketing strategy and assign it a score which results in a corresponding level rating: Gold (highest resource deployment), Silver (managed resource deployment), or Bronze (standardized support).

Moreover, embodiments may encourage terms that cross-functionally communicate anticipated participation outcomes. Still further, algorithms may process resource allocation level information along with case specific demographics (and pricing) and calculate an expected change in employee participation and risk profile. This may then be used to develop an appropriate price for the case.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

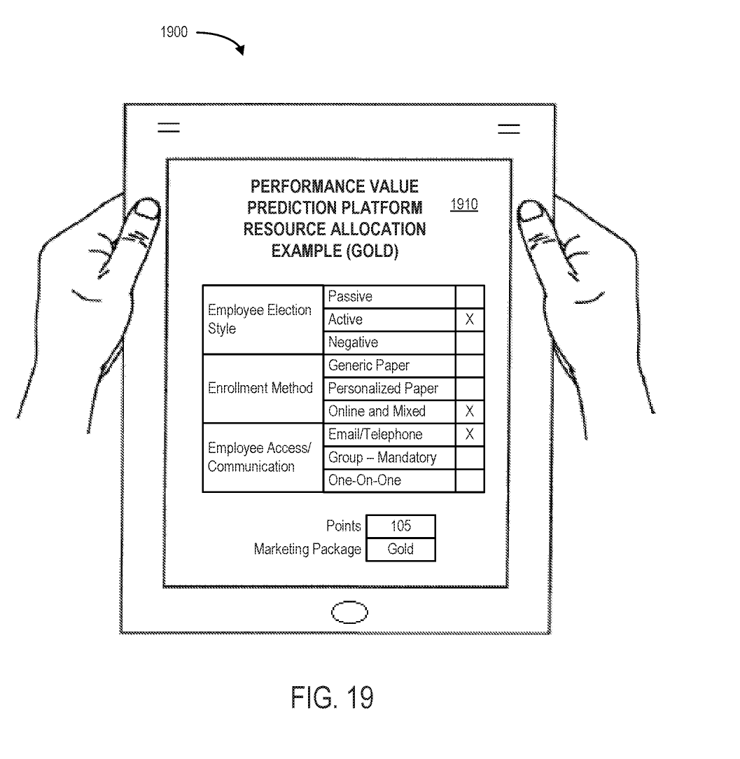

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of communication addresses, embodiments may instead be associated with other types of communications (e.g., chat implementations, web-based messaging, etc.). Similarly, although a certain number of resource allocation levels were described in connection some embodiments described herein, other numbers of resource allocations levels might be used instead (e.g., a system might automatically assign a quote to one of ten possible resource allocation levels). Still further, the displays and devices illustrated herein are only provided as examples, and embodiments may be associated with any other types of user interfaces. For example, FIG. 19 illustrates a handheld tablet computer 1900 displaying a resource allocation display 1910 according to some embodiments. The resource allocation display 1910 might include user-selectable graphical data providing information about employee enrollment process that can be selected and/or modified by a user of the handheld computer 1900.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to automatically generate a predicted performance value for an enterprise system via an automated back-end application computer server, comprising:
(a) a data store containing electronic records representing a plurality of potential associations and, for each potential association, a set of attribute variables;
(b) an automated resource allocation interface computer programmed to:
(i) receive, for a plurality of resource allocation categories, a selected sub-category from a set of potential sub-categories,
(ii) based on the selected sub-categories, calculate a resource allocation score for the enterprise system, and
(iii) based on the resource allocation score, assign the enterprise system to one of a pre-determined number of resource allocation levels;
(c) the back-end application computer server, coupled to the data store, programmed to:
(iv) access the electronic records in the data store,
(v) based on the set of attribute variables, automatically generate a present total number of associations,
(vi) receive the assigned resource allocation level for the enterprise system,
(vii) based on the assigned resource allocation level and the set of attribute variables, automatically forecast a future change to the total number of associations,
(viii) based at least in part on the present total number of associations and the forecasted future change to the total number of associations, automatically calculate the predicted performance value associated with the enterprise system, and
(ix) transmit an indication of the predicted performance value associated with the enterprise system to generate an interactive user interface display; and
(d) a communication port coupled to the back-end application computer server to facilitate a transmission of electronic messages associated with the interactive user interface display via a distributed communication network.

2. The system of claim 1, wherein risk information is calculated for the automatic forecast of the future change to the total number of associations, and the predicted performance value is further based on the risk information.

3. The system of claim 2, wherein the automatic forecast of the future change to the total number of associations is based at least in part on: (i) an association type, (ii) at least one time-related attribute variable, and (iii) elements of the present total number of within bands of time periods associated with the time-related attribute value.

4. The system of claim 3, wherein the automatic forecast of the future change to the total number of associations is further based at least in part on characteristics associated with individual elements within each time period band.

5. The system of claim 3, wherein at least one potential sub-category comprises one of: (i) a passive association processes, (ii) an active association process, and (iii) a negative association process.

6. The system of claim 1, wherein the enterprise system is associated with an employer and the potential associations represented by the electronic records represent potential voluntary benefit insurance policies.

7. The system of claim 6, wherein at least one of the voluntary benefit insurance policies comprise at least one of: (i) life insurance, (ii) accidental death and dismemberment insurance, (iii) short term disability insurance, (iv) long-term disability insurance, (v) critical illness insurance, (vi) voluntary accident insurance, (vii) dental insurance, (viii) vision insurance, (ix) automotive insurance, and (x) home insurance.

8. The system of claim 6, wherein the automated resource allocation interface comprises a voluntary group insurance benefit enrollment strategy interface, the resource allocation levels are associated with a marketing budget allocation, and the resource allocation categories include at least one of: (i) an employee election style, (ii) an enrollment method, (iii) an employee access and communications process, (iv) a marketing strategy, (v) a producer status, and (vi) a pricing event.

9. The system of claim 8, wherein the potential sub-categories include at least one of: (i) a passive election style, (ii) an active election style, (iii) a negative election style, (iv) generic paper enrollment, (v) personized paper enrollment, (vi) online and mixed enrollment, (vii) benefit fair and group optional communications, (viii) email and telephonic communications, (ix) one-on-one communications, (x) a generic marketing strategy, (xi) a one or two touch marketing strategy, (xii) a three or more touch marketing strategy, (xiii) a very important person producer status indication, (xiv) a new pricing event, and (xv) an in-force pricing event.

10. The system of claim 6, wherein the set of attribute variables includes at least one of (i) an enrollment type, (ii) gender, (iii) an age or date of birth value or band of values, (iv) an income value or band of values, (v) demographic information, (vi) socio-economic status data, (vii) third party data, and (viii) medical data.

11. The system of claim 6, wherein the future change to the total number of associations includes at least one of: (i) new employees predicted to be hired in the future, (ii) employees predicted to retire in the future (iii) employee movement between age bands in the future, and (iv) employee movement between income bands in the future.

12. The system of claim 6, wherein the predicted performance value associated with the employer comprises at least one of: (i) a predicted price, (ii) a predicted loss ratio, and (iii) a predicted combined loss ratio.

13. The system of claim 12, wherein risk information is calculated for the automatic forecast of the future change to the total number of associations, and the predicted performance value is further based on the risk information.

14. The system of claim 13, wherein the risk information comprises at least one of: (i) an overall number of insurance claims, and (ii) an overall insurance claim value amount.

15. A computerized method to automatically generate a predicted performance value for an enterprise system via an automated back-end application computer server, comprising:
receiving, by an automated resource allocation interface computer for a plurality of resource allocation categories, a selected sub-category from a set of potential sub-categories;
based on the selected sub-categories, calculating a resource allocation score for the enterprise system;
based on the resource allocation score, assigning the enterprise system to one of a pre-determined number of resource allocation levels;
automatically accessing, by the back-end application computer server, electronic records from a data store containing electronic records representing a plurality of potential associations and, for each potential association, a set of attribute variables;
based on the set of attribute variables, automatically generating a present total number of associations;
receiving the assigned resource allocation level for the enterprise system;
based on the assigned resource allocation level and the set of attribute variables, automatically forecasting a future change to the total number of associations;
based at least in part on the forecasted future change to the total number of associations, automatically calculating the predicted performance value associated with the enterprise system; and
transmitting an indication of the predicted performance value associated with the enterprise system to generate an interactive user interface display.

16. The method of claim 15, further comprising:
prior to said receiving the selected sub-category:
receiving a request for proposal from a potential client, and
responsive to the request for proposal, determining an appropriate marketing strategy for the potential client, wherein the selected sub-categories reflect the appropriate marketing strategy; and
after said transmitting the indication of the predicted performance value associated with the enterprise system to generate the interactive user interface display:
pricing the request for proposal based at least in part on the predicted performance value,
arranging for a final sale to the potential client,
tracking and reporting enrollment results, and
updating a final price for the client based on the enrollment results.

17. The method of claim 15, wherein the enterprise method is associated with an employer and the potential associations represented by the electronic records represent potential voluntary benefit insurance policies.

18. The method of claim 17, wherein the future change to the total number of associations includes at least one of: (i) new employees predicted to be hired in the future, (ii) employees predicted to retire in the future (iii) employee movement between age bands in the future, and (iv) employee movement between income bands in the future.

19. The method of claim 17, wherein the predicted performance value associated with the employer comprises at least one of: (i) a predicted price, (ii) a predicted loss ratio, and (iii) a predicted combined loss ratio.

20. The method of claim 19, wherein risk information is calculated for the automatic forecast of the future change to the total number of associations, and the predicted performance value is further based on the risk information.

21. The method of claim 20, wherein the interactive user interface display includes: (i) predicted enrollment change values broken down by both employee income bands and employee age bands, (ii) an original estimator tool load value, (iii) a needed load value, (iv) an initial loss ratio value, (v) a new loss ratio value, (vi) an existing volume value, (vii) a forecast change in volume value, and (viii) an expected volume value.

22. A non-tangible, computer-readable medium storing instructions, that, when executed by a processor, cause the processor to perform a method to automatically generate a predicted performance value for an enterprise system via an automated back-end application computer server, the method comprising:
receiving, by an automated resource allocation interface computer for a plurality of resource allocation categories, a selected sub-category from a set of potential sub-categories;
based on the selected sub-categories, calculating a resource allocation score for the enterprise system;
based on the resource allocation score, assigning the enterprise system to one of a pre-determined number of resource allocation levels;
automatically accessing, by the back-end application computer server, electronic records from a data store containing electronic records representing a plurality of potential associations and, for each potential association, a set of attribute variables;
based on the set of attribute variables, automatically generating a present total number of associations;
receiving the assigned resource allocation level for the enterprise system;
based on the assigned resource allocation level and the set of attribute variables, automatically forecasting a future change to the total number of associations;
based at least in part on the forecasted future change to the total number of associations, automatically calculating the predicted performance value associated with the enterprise system; and
transmitting an indication of the predicted performance value associated with the enterprise system to generate an interactive user interface display.

23. The medium of claim 22, wherein the enterprise medium is associated with an employer and the potential associations represented by the electronic records represent potential voluntary benefit insurance policies.

24. The medium of claim 23, wherein the future change to the total number of associations includes at least one of: (i) new employees predicted to be hired in the future, (ii) employees predicted to retire in the future (iii) employee movement between age bands in the future, and (iv) employee movement between income bands in the future.

25. The medium of claim 23, wherein the predicted performance value associated with the employer comprises at least one of: (i) a predicted price, (ii) a predicted loss ratio, and (iii) a predicted combined loss ratio.

26. The medium of claim 25, wherein risk information is calculated for the automatic forecast of the future change to the total number of associations, and the predicted performance value is further based on the risk information.

27. The medium of claim 26, wherein the risk information comprises at least one of: (i) an overall number of insurance claims, and (ii) an overall insurance claim value amount.
